(19) United States
(12) Patent Application Publication
(10) Pub. No.: US 2006/0148981 A1
(43) Pub. Date: Jul. 6, 2006

(54) Method for producing stable aqueous polymer dispersions based on conjugated alphatic dienes and vinyl aromatic compounds

(75) Inventors: Jurgen Schmidt-Thummes, Neuhofen (DE); Jurgen Hartmann, Frankenthal (DE); Chung-Ji Tschang, Bad Durkheim (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: BASF Aktiengesellschaft, Ludwigshafen (DE)

(21) Appl. No.: 10/541,206

(22) PCT Filed: Dec. 24, 2003
(86) PCT No.: PCT/EP03/14873

§ 371 Date: Jul. 5, 2005

(30) Foreign Application Priority Data
Jan. 7, 2003 (DE) 103 00 460.2

(51) Int. Cl. C08F 2/26

(52) U.S. Cl. 524/745

(57) ABSTRACT

The present invention provides a process for preparing a stable aqueous copolymer dispersion by free-radically initiated aqueous emulsion polymerization of a) from 19.9 to 80 parts by weight of conjugated aliphatic dienes [monomers a)], b) from 19.9 to 80 parts by weight of vinylaromatic compounds [monomers b)], c) from 0.1 to 10 parts by weight of ethylenically unsaturated carboxylic acids and/or dicarboxylic acids [monomers c)], d) from 0 to 20 parts by weight of ethylenically unsaturated carbonitriles [monomers d)], and e) from 0 to 20 parts by weight of copolymerizable compounds other than monomers b) [monomers e)], the total amount of ethylenically unsaturated monomers a) to e) being 100 parts by weight, in the presence of water and from 0.1 to 5 parts by weight, based on the total monomer amount, of emulsifiers comprising f) sulfuric monoesters of ethoxylated fatty acid alcohols and/or g) salts of esters and monoesters of alkylpolyoxyethylenesulfosuccinates, from 15 to 85% by weight of the total emulsifiers used being added within the time taken to reach up to 40% of the total conversion of the monomers a) to e), and from 1 to 50% of the carboxylic acid groups deriving from the monomers c) being neutralized by addition of base.

The present invention provides a process for preparing a stable aqueous copolymer dispersion by free-radically initiated aqueous emulsion polymerization of
a) from 19.9 to 80 parts by weight of conjugated aliphatic dienes [monomers a)],
b) from 19.9 to 80 parts by weight of vinylaromatic compounds [monomers b)],
c) from 0.1 to 10 parts by weight of ethylenically unsaturated carboxylic acids and/or dicarboxylic acids [monomers c)],
d) from 0 to 20 parts by weight of ethylenically unsaturated carbonitriles [monomers d)],
   and
e) from 0 to 20 parts by weight of copolymerizable compounds other than monomers b) [monomers e)],
   the total amount of ethylenically unsaturated monomers a) to e) being 100 parts by weight, in the presence of water and from 0.1 to 5 parts by weight, based on the total monomer amount, of emulsifiers comprising
f) sulfuric monoesters of ethoxylated fatty acid alcohols and/or
g) salts of esters and monoesters of alkylpolyoxyethylenesulfosuccinates,
   from 15 to 85% by weight of the total emulsifiers used being added within the time taken to reach up to 40% of the total conversion of the monomers a) to e), and from 1 to 50% of the carboxylic acid groups deriving from the monomers c) being neutralized by addition of base, wherein the partial neutralization of the monomers c) takes place before the polymerization.

EP-B 819708 discloses aqueous copolymer dispersions based on conjugated aliphatic dienes and vinylaromatic compounds which exhibit good stability toward polyvalent ions, calcium ions for example, particularly at high temperatures and under the action of shearing forces, and also a process for preparing them. Characteristic of the preparation process is the fact that specific emulsifiers are used and are added to the polymerization mixture in accordance with a defined profile and that the likewise copolymerized ethylenically unsaturated monocarboxylic and/or dicarboxylic acids are partly neutralized during the polymerization reaction. A disadvantage of that process is that the resulting copolymer dispersions contain coagulum in amounts which interfere with the application of the aqueous copolymer dispersions in various fields of application and which must therefore be separated off in expensive and time-consuming filtration operations.

It is an object of the present invention to provide an improved preparation process for aqueous copolymer dispersions based on conjugated aliphatic dienes and vinylaromatic compounds which provides such aqueous copolymer dispersions with relatively low amounts of coagulum.

We have found that this object is achieved by the process defined at the outset.

The process of the invention prepares the aqueous copolymer dispersions using frequently

from 25 to 70 parts by weight of monomers a),

from 25 to 70 parts by weight of monomers b),

from 0.1 to 8 parts by weight of monomers c),

from 0 to 15 parts by weight of monomers d), and

from 0 to 15 parts by weight of monomers e)

and often

from 25 to 60 parts by weight of monomers a),

from 25 to 70 parts by weight of monomers b),

from 1 to 5 parts by weight of monomers c),

from 0 to 10 parts by weight of monomers d), and

from 0 to 10 parts by weight of monomers e).

Suitable conjugated aliphatic dienes [monomers a)] include preferably butadiene, isoprene, 1,3-pentadiene, dimethylbutadiene and/or cyclopentadiene. Particular vinylaromatic compounds [monomers b)] include styrene, α-methylstyrene and/or vinyltoluene. As ethylenically unsaturated carboxylic acids and/or dicarboxylic acids [monomers c)] it is preferred to use α,β-monoethylenically unsaturated monocarboxylic and dicarboxylic acids having 3 to 6 carbon atoms, such as acrylic acid, methacrylic acid, maleic acid, fumaric acid, and itaconic acid. Preferred ethylenically unsaturated carbonitriles are acrylonitrile and/or methacrylonitrile [monomers d)] and preferred copolymerizable compounds [monomers e)] are esters of acrylic and/or methacrylic acid in which the alkyl group contains 22 carbon atoms or less, examples being methyl (meth)acrylate, ethyl (meth)acrylate, isopropyl (meth)acrylate, butyl (meth)acrylate, 2-ethylhexyl (meth)acrylate, and allyl esters of saturated monocarboxylic acids, vinyl esters, vinyl ethers, vinyl ketones, dialkyl esters of unsaturated dicarboxylic acids, vinyl acetate and/or vinyl pyridine, vinyl chloride, and vinylidene chloride.

The emulsifiers are used in accordance with the invention preferably in amounts of from 0.2 to 4.5 parts by weight per 100 parts by weight of the abovementioned monomers a) to e). Emulsifiers suitable in accordance with the invention include in particular sulfuric monoesters of ethoxylated fatty alcohols, which are composed of a straight-chain or branched alkyl radical having 8 to 18 carbon atoms which is linked via an ether group to a poly- or oligo-ethyleneoxy sequence and whose end groups consist of a sulfate radical. Suitable poly- or oligo-ethyleneoxy sequences include ethylene oxide oligomers having a degree of polymerization of from 2 to 30 ethylene oxide units, preferably from 2 to 7 ethylene oxide units.

Particularly preferred fatty alcohol ether sulfates are those comprising a C₈-C₁₈ alkyl radical as fatty alcohol, e.g., caprylyl, capryl, lauryl, myristyl, oleyl or elaidyl alcohol. Particular preference is given to lauryl oligoethylenoxysulfate, palmityl oligoethylenoxysulfate, stearyl oligoethylenoxysulfate, and oleyl oligoethylenoxysulfate, the oligoethylenoxy sequence being composed with particular preference of from 2 to 7 ethylene oxide units.

As fatty alcohol in this case it is possible to use the pure starting compound or else the mixtures of homologous and isomeric alkyl radicals that are frequently obtained in the case of the synthetic fatty alcohols, an example being a mixture of C₁₂ and C₁₃ fatty alcohols. It is typical for the degree of ethoxylation to express only the average value of a distribution.

The free acid group of the sulfate radical is normally present in neutralized form as the ammonium salt or an alkali metal salt, although neutralization can also be carried out during the metered addition, by the base that is used.

As emulsifiers in accordance with the invention it is additionally possible to use esters or monoesters of alkylpolyoxyethylenesulfosuccinates. In these compounds the sulfosuccinic acid is singly or doubly esterified with poly- or oligo-ethylene oxide having from 2 to 30 ethylene oxide units, preferably from 2 to 7 ethylene oxide units, in particular from 2 to 5 ethylene oxide units, the end group of said esters and monoesters consisting of an alkyl radical having 8 to 18 carbon atoms which is straight-chain or branched. C₈-C₁₈ carbon-containing alkyl radicals include the following in particular: caprylyl, capryl, lauryl, myristyl, stearyl, and elaidyl alcohol.

The free-radical aqueous emulsion polymerization is initiated in a manner familiar to the skilled worker by water-soluble free-radical initiators. Particular such initiators include organic and/or inorganic peroxides, such as alkali metal peroxodisulfates and/or azo compounds, for example, or combined systems composed of at least one reducing agent and at least one peroxide and/or hydroperoxide, such as tert-butyl hydroperoxide and the sodium salt of hydroxymethanesulfinic acid, or hydrogen peroxide and ascorbic acid, or combined systems additionally comprising a small amount of a metal compound which is soluble in the polymerization medium and whose metallic component is able to exist in a plurality of valence states, e.g., ascorbic acid/iron(II) sulfate/hydrogen peroxide, in which the ascorbic acid may frequently be replaced by the sodium salt of hydroxymethanesulfinic acid, sodium sulfite, sodium hydrogensulfite and/or sodium disulfite and the hydrogen peroxide by tert-butyl hydroperoxide or alkali metal peroxide sulfates and/or ammonium peroxodisulfates. Instead of a water-soluble iron(II) salt it is common to use a combination of water-soluble Fe/V salts. The initiator system can be added continuously or in stages at the rate at which it is consumed in the course of the free-radical aqueous emulsion polymerization. In each specific case this will depend in a manner known per se both on the chemical nature of the initiator system and on the polymerization temperature. Very particular preference is given to peroxides, e.g., alkali metal peroxodisulfates, such as sodium or ammonium peroxodisulfate. The free-radical initiators, which are normally in solution in water, are generally added to the polymerization reactor via a separate feed.

The ideal amount of water-soluble initiators can easily be determined by appropriate preliminary tests. Normally the water-soluble initiators are added in an amount of from 0.1 to 2.0% by weight, based on the total mass of the monomers to be polymerized.

For the emulsion polymerization of the invention it is additionally possible to add the known molecular weight regulators, such as mercapto compounds, e.g., tertiary dodecyl mercaptan, or dimeric α-methylstyrene. Further auxiliaries can be added as well, such as complexing agents, an example being ethylenediaminetetraacetic acid Na salt (EDTA-Na), for disruptive metal ions, for example, inhibitors, e.g., hydroquinone monomethyl ether, or foam suppressants, to the emulsion polymerization. The molecular weight regulators and auxiliaries are known and are described for example in Houben-Weyl, Methoden der organischen Chemie, Vol. XIV/1, p. 297 ff., 1961, Stuttgart.

In the preparation of the aqueous dispersions of the invention it is important that from 15 to 85% by weight, preferably from 30 to 85% by weight, of the total emulsifiers used are added to the reaction mixture within the time taken to reach up to 40%, preferably 35%, of the total conversion of the starting components. The rate of conversion of the starting components can easily be calculated by determining the solids content of the dispersion by means of an evaporation sample or by means of reaction calorimetry measurements.

In one particular embodiment of the emulsion polymerization of the invention for preparing the aqueous dispersion of copolymers it can be advantageous to add up to 15% by weight of the total amount of emulsifiers used to the reaction mixture right at the beginning of the polymerization and then to add the remainder, i.e., up to 85% by weight, of the total emulsifiers used within the time taken to reach up to 40% of the total conversion of the starting components.

The metering rate of the emulsifiers during the emulsion polymerization is also dependent on the target particle size of the end polymers and on the reaction rate and can easily be determined by means of a few preliminary tests. The optimum is defined by a minimum amount of precipitation (coagulum) during polymerization, the attainment of the desired end particle size and particle size distribution, and the maximum stability of the resultant polymer dispersion toward polyvalent ions.

The remainder of the emulsifiers, i.e., from 85 to 15% by weight of the total emulsifiers used, can be metered into the reaction mixture during the remaining polymerization time or else added to the dispersion after the polymerization has been ended.

Also decisive for the desired properties of the aqueous copolymer dispersion is the 1 to 50% neutralization of the copolymerizable carboxylic acids and/or dicarboxylic acids [monomers c)] used for the polymerization. Preferably from 5 to 45% of the carboxylic acid groups deriving from them are neutralized with bases.

Particularly suitable bases are aqueous solutions of alkali metal oxides or hydroxides, especially aqueous ammonium, sodium or potassium hydroxide solutions.

Essential to the process is that the partial neutralization of the carboxylic acid groups deriving from the monomers c) takes place prior to the actual polymerization reaction. This is done, for example, by partially neutralizing the carboxylic acid monomers c) with the appropriate amount of base in a separate vessel and only then supplying them to the polymerization.

It has proven advantageous if components a) to g) are supplied to the polymerization reactor during the polymerization via a common supply line. In one embodiment of the process of the invention components a) to g) and at least part of the water are mixed to an emulsion by a mixing means during their supply, the monomers c) being used in the partially neutralized form.

As mixing means in the process of the invention it is possible to use one mixer or else two or more mixers, which can be mixers of identical or different construction which are used in any order, arrangement, and combination—such as, for example, serial arrangement of all the mixers, a combination of parallel arrangement and serial arrangement, or parallel arrangement of all the mixers. Where two or more mixers are used the serial arrangement is preferred.

Particularly suitable mixers are dynamic mixers, whose mixing elements comprise moving parts, and static mixers, i.e., mixing elements without moving parts in the interior, which operate in particular in accordance with the inline principle.

Suitable mixers are described for example in A. Echte, Handbuch der technischen Polymerchemie, VCH Verlagsgesellschaft Weinheim, p. 104 ff. (1993).

Examples of suitable dynamic inline mixers are the Kratz heat exchangers described in ZFL-Zeitschrift für ebensmitteltechnologie und-Verfahrenstechnik (1982) 33(3), p. 139 ff., comminuting machines operating in accordance with the rotor-stator principle, such as toothed-wheel dispersers, colloid mills and corundum disk mills, and high-pressure and ultrasonic homogenizers.

Further suitable dynamic inline mixers are continuous tube mixers.

Suitable static inline mixers are, for example, those described in ZFL-Zeitschrift für Lebensmitteltechnologie und-Verfahrenstechnik (1982) 33(3) p. 139 ff., such as Ross-ISG mixers, in which the fluid stream is passed through perforated internals which break it down into substreams, which are then displaced laterally and recombined in a different order, or static mixers which comprise two or more fixed mixing elements of identical kind which are installed one behind another in a tube or duct and are each staggered by 90° (e.g., Kenics, Sulzer SMV, and Sulzer SMX mixers).

Further suitable static inline mixers are shear mixers, such as the jet dispersers described in EP-B-101 007.

Further suitable mixers also include apparatuses for inline emulsification, such as membranes, jet mixers, mixing nozzles, and curved tubular apparatuses having an essentially circular or ellipsoidal cross section.

As the mixing means it is preferred to use at least one inline mixer which advantageously is mounted in the supply line immediately before the reaction vessel.

With particular preference the mixing means comprises a dynamic mixer, a static mixer and/or a mixing nozzle. If two mixers are used they are connected in series. As the dynamic mixer in this case it is preferred to use a continuous tube mixer or a toothed-wheel disperser, e.g., of the Megatron type from Kinematica.

In a further embodiment of the process of the invention components a) to g) and at least part of the water are mixed to an emulsion by a mixing means during their supply, but at least part of the base required for partial neutralization of the monomers c) is metered into the common supply line. In this case it is particularly advantageous if at least part of the base required for partial neutralization of the monomers c) is metered into the common supply line upstream of the mixing means. Frequently ≧50% by weight, ≧60% by weight, ≧70% by weight, ≧80% by weight, ≧90% by weight or even all of the base required for partial neutralization of the monomers c) is metered into the common supply line upstream of the mixing means.

With advantage the volume streams of the individual components a) to g), the base required for partial neutralization of the monomers c), and the water required to form an aqueous emulsion, along with any further, customary additives, are supplied at regulated rates to the supply line upstream of the mixing means. These separate rate regulations on the individual streams in particular allow simple realization of the specific profile of requirements for the preparation process of the invention in terms of the amount of emulsifier for a given monomer conversion and partial neutralization of the monomers c).

In a further embodiment of the process of the invention the free-radically initiated aqueous emulsion polymerization takes place in the presence of a polymer seed. The amount of polymer seed is from 0.01 to 2.0 parts by weight, frequently from 0.1 to 1.5 parts by weight, and often from 0.1 to 1.0 part by weight, based in each case on 100 parts by weight of the total monomer amount.

The weight-average particle diameter of the polymer seed used is frequently ≦80 nm or ≦60 nm and in particular ≦50 nm or ≦40 nm. The determination of the weight-average particle diameters is known to the skilled worker and is accomplished for example by the method of the analytical ultracentrifuge. Weight-average particle diameter for the purposes of this text is understood to be the weight-average D_{w50} figure determined in accordance with the method of the analytical ultracentrifuge (in this regard, cf. S. E. Harding et al., Analytical Ultracentrifugation in Biochemistry and Polymer Science, Royal Society of Chemistry, Cambridge, Great Britain 1992, Chapter 10, Analysis of Polymer Dispersions with an Eight-Cell AUC Multiplexer: High Resolution Particle Size Distribution and Density Gradient Techniques, W. Mächtle, pages 147 to 175).

It is advantageous if the polymer seed used is monomodal and has a narrow particle size distribution. Narrow particle size distribution for the purposes of this text means that the ratio of the weight-average particle diameter D_{w50} as determined by the method of the analytical ultracentrifuge to the number-average particle diameter D_{N50} [D_{w50}/D_{N50}] is ≦2.0, preferably ≦1.5, and more preferably ≦1.2 or ≦1.1.

Normally the polymer seed is used in the form of an aqueous polymer dispersion. The aforementioned amounts data relate to the polymer solids fraction of the aqueous polymer seed dispersion; they are therefore stated as parts by weight of polymer seed solids based on 100 parts by weight of monomers.

The preparation of a polymer seed is known to the skilled worker and is normally accomplished by charging a relatively small amount of monomers and a relatively large amount of emulsifiers to a reaction vessel together with deionized water and at reaction temperature adding a sufficient amount of polymerization initiator.

Preference is given in accordance with the invention to using a polymer seed having a glass transition temperature ≧50° C., frequently ≧60° C. or ≧70° C. and often ≧80° C. or ≧90° C. A polystyrene or polymethyl methacrylate polymer seed is especially preferred.

In the process of the invention all or some of the polymer seed can be included in the initial charge to the polymerization reactor and any remainder could be added in the course of the emulsion polymerization. Often all of the polymer seed is charged to the polymerization reactor before the polymerization is initiated.

In a further embodiment at least part of the water and, if desired, parts of one or more of components a) to g) and also parts or all of a polymer seed and of further, customary additives are charged to the polymerization reactor and then the polymerization is initiated. Any remainders of these components and/or all of them are supplied to the polymerization reactor after the free-radical polymerization has been initiated, preferably into the liquid phase of the reaction mixture. For this purpose it is inconsequential whether the supply takes place via an immersed supply line whose outlet opening is arranged within the liquid phase or whether an opening of the polymerization reactor in the region of the liquid phase, such as in the lower region of the reactor wall or on the reactor floor, for example, is used for the supply.

It is essential that the free-radically initiated aqueous emulsion polymerization takes place under an inert gas atmosphere, such as under nitrogen or argon.

Polymerization pressure and temperature, on the other hand, are of relatively minor importance. It is general to operate at temperatures from 20 to 150° C., preferably at temperatures from 60 to 100° C.

After the actual polymerization process has been ended it is preferred to stir the system for a number of hours while maintaining the polymerization temperature. This can be followed by customary measures for removing residual monomer, for adjusting the pH, or other methods of setting defined end properties.

The total amount of deionized water used in the process of the invention is calculated such that the aqueous copolymer dispersion obtained has a polymer solids content ≧30% and ≦70% by weight, frequently ≧35% and ≦65% by weight, and often ≧40% and ≦60% by weight, based in each case on the aqueous copolymer dispersion.

By virtue of the process of the invention it is possible to obtain stable aqueous copolymer dispersions based on conjugated aliphatic dienes and vinylaromatic compounds that have a markedly reduced coagulum content. As a result, product losses through coagulum formation are reduced and at the same time the filtration times are shortened and the corresponding service life of the filters used to separate off coagulum are prolonged.

### EXAMPLES

### Analysis

The solids contents were determined by drying an aliquot in a drying cabinet at 140° C. for 6 hours. Two separate measurements were carried out in each case. The figure stated in each of the examples represents the average of the two results.

The particle sizes of the polymer seed were determined by the method of the analytical ultracentrifuge (W. Mächtle, Makromolekulare Chemie, Vol 185 (1984) pages 1025 to 1039).

The average diameter of the copolymer particles was determined generally by dynamic light scattering on an aqueous dispersion with a concentration of from 0.005 to 0.01 percent by weight at 23° C. by means of an Autosizer IIC from Malvern Instruments, England. The parameter stated is the average diameter of the cumulant evaluation (cumulant z-average) of the measured autocorrelation function (ISO standard 13321).

The fine coagulum contents were determined from the sieve residue: in a modification of DIN 53786 1 kg of each aqueous polymer dispersion was filtered through a sieve with a mesh size of 10 μm. The sieve residue was washed with deionized water, then dried at 80° C. for 5 hours, and subsequently weighed. The data is given as parts by weight of fine coagulum per million parts by weight of aqueous copolymer dispersion (ppm). Two separate measurements were conducted in each case. The figure given in each of the examples represents the average of the two results.

### Example 1

150 I polymerization reactor with MIG stirrer was charged at from 20 to 25° C. (room temperature) with
13.680 kg of deionized water,
0.003 kg of EDTA-Na salt (Trilon® B, BASF AG, Germany),
0.089 kg of a 28% strength by weight aqueous solution of the sulfuric monoester of an ethoxylated C₁₂ fatty alcohol (average degree of ethoxylation 2 to 3; Texapon® NSO from Cognis Deutschland GmbH & Co. KG)
2.12 kg of an aqueous polymer latex (prepared by free-radically initiated emulsion polymerization of styrene; polymer solids content 33% by weight) having a weight-average particle diameter D_{w50} of 30 nm,
0.975 kg of butadiene, and
5% by weight of feeds I and II described below
   and this initial charge was heated to 95° C. with stirring (90 rpm) under a nitrogen atmosphere. When the reaction mixture had reached 80° C. 1.43 kg of a 7% strength by weight aqueous solution of sodium peroxodisulfate were added to it. When the system reached 95° C., the remainders of feeds I and II and also all of feeds III and IV were metered in with consistent feed flows over the course of two and a half hours, during which stirring and the reaction temperature were maintained, the two feeds beginning simultaneously and the pressure at the end of the feed being 9:1 bar (abs.). Feeds I, II, and III were supplied to the polymerization reactor at the floor via a common supply line. Immediately before the entry of the supply line into the polymerization reactor there was a Megatron mixer (model MT 36-48 Dex-DW from Kinematica Inc.) which was operated at 5000 rpm. Feed IV was added via a separate supply line at the floor of the polymerization reactor.

After the end of feeds I to IV polymerization was continued at 95° C. for one and a half hours. Thereafter 0.78 kg of a 15% strength by weight aqueous ammonium hydroxide solution was added to the aqueous copolymer dispersion and stirring was continued for 15 minutes.

The polymerization reactor was let down to atmospheric pressure and then feeds V and VI were metered into the aqueous copolymer dispersion in parallel, beginning at the same time, over 2 hours via two separate supply lines at the top of the polymerization reactor. The aqueous copolymer dispersion was then cooled to 60° C. and the entire contents of the reactor were transferred via a 400 μm bag filter into a deodorization tank. The filtration process took 10 minutes. Thereafter 4 bar steam was introduced at the base of the deodorization tank with further stirring at this temperature for 3 hours and the emergent steam was supplied to a condenser for the purpose of separating out volatile constituents. Aqueous copolymer dispersion entrained in this process was separated off and recycled to the deodorization tank. Subsequently the aqueous copolymer dispersion was cooled to room temperature. The amount of sieve coagulum remaining in the bag filter was 80 g (moist). The polymer solids content was 55.5% by weight and the amount of fine coagulum was 105 ppm, based in each case on the aqueous copolymer dispersion. The average particle size was measured at 140 nm.

Feed I is an aqueous solution prepared from:
16.70 kg of deionized water
0.52 kg of a 25% strength by weight aqueous solution of sodium hydroxide
1.16 kg of a 28% strength by weight aqueous solution of Texapon® NSO

Feed II:
28.25 kg of styrene
2.25 kg of acrylic acid
0.57 kg of tert-dodecyl mercaptan

Feed III:
18.53 kg of butadiene

Feed IV:
5.71 kg of a 7% strength by weight aqueous solution of sodium peroxodisulfate

Feed V:
2.00 kg of a 5% strength by weight aqueous solution of tert-butyl hydroperoxide

Feed VI is a reducing agent solution prepared from:
0.10 kg of sodium bisulfite
0.07 kg of acetone
1.09 kg of deionized water

### COMPARATIVE EXAMPLE

Example 1 was repeated except that feed I was supplied via a feed line at the top and feeds II to IV via a common feed line at the floor of the polymerization reactor.

The aqueous copolymer dispersion obtained was filtered, the filtration process taking 30 minutes. The quantity of sieve coagulum was found to be 890 g (moist). The filtered aqueous copolymer dispersion had a polymer solids content of 54.1% by weight and contained 165 ppm of fine coagulum, based in each case on the aqueous copolymer dispersion. The particle size was measured at 134 nm.

1. A process for preparing a stable aqueous copolymer dispersion comprising free-radically initiated aqueous emulsion polymerization of
a) from 19.9 to 80 parts by weight of conjugated aliphatic dienes,
b) from 19.9 to 80 parts by weight of vinylaromatic compounds,
c) from 0.1 to 10 parts by weight of ethylenically unsaturated carboxylic acids and/or dicarboxylic acids,
d) from 0 to 20 parts by weight of ethylenically unsaturated carbonitriles, and
e) from 0 to 20 parts by weight of copolymerizable compounds other than monomers b),
the total amount of ethylenically unsaturated monomers a) to e) being 100 parts by weight, in the presence of water and from 0.1 to 5 parts by weight, based on the total monomer amount, of emulsifiers comprising
f) sulfuric monoesters of ethoxylated fatty acid alcohols and/or
g) salts of esters and monoesters of alkylpolyoxyethylenesulfosuccinates,
from 15 to 85% by weight of the total emulsifiers used being added within the time taken to reach up to 40% of the total conversion of the monomers a) to e), and from 1 to 50% of the carboxylic acid groups deriving from the monomers c) being neutralized by addition of base, wherein the partial neutralization of the monomers c) takes place before the polymerization.

2. The process as claimed in claim 1, wherein components a) to g) are supplied to the polymerization reactor during the polymerization via a common supply line.

3. The process as claimed in claim 2, wherein components a) to g) and at least part of the water are mixed to an emulsion by a mixing means during their supply.

4. The process as claimed in claim 3, wherein said mixing means comprises at least one static mixer, one dynamic mixer and/or one mixing nozzle.

5. The process as claimed in claim 2, wherein at least part of the base required for partial neutralization of the monomers c) is metered into the common supply line.

6. The process as claimed in claim 5, wherein at least part of the base required for partial neutralization of the monomers c) is metered into the common supply line upstream of the mixing means.

7. The process as claimed in claim 1, wherein the free-radically initiated aqueous emulsion polymerization is conducted in the presence of a polymer seed.

8. The process as claimed in claim 7, wherein at least part of the water and, if desired, parts of one or more of components a) to g) and also parts or all of a polymer seed or of further, customary additives are charged to the polymerization reactor and the remainders of these components are supplied to the liquid phase of the reaction mixture after the free-radical polymerization has been initiated.
